(19) United States
(12) Patent Application Publication
(10) Pub. No.: US 2006/0155613 A1
(43) Pub. Date: Jul. 13, 2006

(54) Information handling and processing

(76) Inventors: John Anthony Foran, Dubdin (IE); Joseph Patrick Corcoran, Dublin (IE); Christopher Michael Murphy, Dublin (IE)

Correspondence Address: BIRCH STEWART KOLASCH & BIRCH, PO BOX 747, FALLS CHURCH, VA, 22040-0747, US

(21) Appl. No.: 10/524,442

(22) PCT Filed: Aug. 18, 2003
(86) PCT No.: PCT/IE03/00112

§ 371 Date: Oct. 11, 2005

(30) Foreign Application Priority Data
Aug. 16, 2002 (IE) S2002/0680

(51) Int. Cl. G07F 7/00

(52) U.S. Cl. 705/27

(57) ABSTRACT

The present invention relates to the customisation of information viewed by a web user on contacting a site. The invention particularly relates to a method of displaying on a user computer one or more logos, specific to the particular user, on the user computer contacting a website associated with a merchant computer in a communications system connecting the merchant computer and the user computer, the communications system being also connected to such additional systems server and browser computers as may be necessary to carry out the method.

The present invention relates to the customisation of information viewed by a web user on contacting a site. The invention particularly relates to a method of displaying on a user computer one or more logos, specific to the particular user, on the user computer contacting a website associated with a merchant computer in a communications system connecting the merchant computer and the user computer, the communications system being also connected to such additional systems server and browser computers as may be necessary to carry out the method.

This is at present carried out in such a manner that somebody else controls what is actually displayed to the user or more properly controls it in a manner which is of no advantage to the user. For example, when a merchant displays a branded logo such as, for example, the Visa logo as a means of payment, that is all that is received by the user. However, if the user is part of a group, for example, who use a particular Visa such as AIB Visa, Bank of Ireland Visa or Ulster Bank Visa, this is not displayed. Thus, the generic Visa logo is displayed which is not of any particular advantage to the user. Even more so, it is not of particular advantage to, for example, the Visa card or Credit card provider who has the viewer as a customer.

Further, it would be advantageous for the merchant if, on the merchant displaying a payment method, the merchant could display, for example, the payment method most suitable to the user, thus further reinforcing the user friendliness of the merchant. Thus, instead of a merchant having to display a considerable number of logos for payment such as, for example, Amex, Visa, MasterCard and so on, the merchant would only display the logo or logos required and this would be advantageous both to the merchant and to the user. Needless to say, if the user has more than one payment card, the relevant logos should be displayed.

The term “logo” is used in this specification to encompass not alone a device or word such as a trade mark which one would normally consider to be a logo but also data which is specific to a user or class of users e.g. Bonus saver scheme points provided by a specific scheme; payment instructions or other data.

### STATEMENTS OF INVENTION

According to the invention, there is provided a method of displaying on a user computer one or more logos, specific to the particular user, on the user computer contacting a website associated with a merchant computer in a communications system connecting the merchant computer and the user computer, the communications system being also connected to such additional systems server and browser computers as may be necessary to carry out the method, having had the preparatory steps previously performed of:
preparing at least one logo for display on the user computer on the user computer contacting the merchant computer;
storing the logo and a logo identifier; and
additionally and separately storing the logo identifier on a user file;

then, on the user computer contacting a merchant computer and requesting the downloading of a merchant page having a call code, the steps are preformed of:
the user file is retrieved;
at least one logo identifier is extracted from the user file;
the logo identifier is used to extract the logo;
the logo is added to the merchant page; and
the logo and merchant page are sent to the user computer.

The advantage of this is that in all instances, the necessary logo that should be displayed on the user page is displayed without cluttering the page with the other logos that a merchant might wish to display. However, the merchant will avoid displaying those logos which are of no interest to the customer.

The invention further provides a method of displaying on a user computer one or more logos, specific to the particular user, on the user computer contacting a website associated with a merchant computer in a communications system connecting the merchant computer and the user computer, the communications system being also connected to such additional systems server and browser computers as may be necessary to carry out the method, having had the preparatory steps previously performed of:
preparing at least one logo for display on the user computer on the user computer contacting the merchant computer;
storing the logo and a logo identifier; and
additionally storing the logo identifier on a user file;
the method comprising:
receiving notification of a request having been received by a merchant computer for the downloading of a merchant page having a call code;
retrieving the user file;
extracting at least one logo identifier from the user file;
extracting the logo; and
having the logo sent for addition to the merchant page for subsequent transfer to the user computer.

Alternatively, the invention provides a method of displaying on a user computer one or more logos, specific to the particular user, on the user computer contacting a website associated with a merchant computer in a communications system connecting the merchant computer and the user computer, the communications system being also connected to such additional systems server and browser computers as may be necessary to carry out the method, some or all of the merchant computer and the additional systems server and browser computers are outside the jurisdiction and for which method there is available for the user computer having been previously prepared, at least one logo for display on the user computer and a logo identifier stored on a user file, the method comprising::
the user computer contacts the merchant computer;
the user computer sends a request for the downloading of a merchant page having a call code;

said request comprising additional instructions for:
the retrieval of the user file;
extraction of at least one logo identifier from the user file;
retrieval of the logo;
the sending of the logo to the merchant computer with instructions to attach the logo to the merchant page;
and then, on the logo having been attached to the merchant page, the user computer receives the page and logo for subsequent use.

In any of the methods described above, in which there is more than one logo stored in the user file and on a request for downloading a merchant page, the logo retrieved is chosen having regard to the call code on the merchant page.

Ideally, the logo extracted is chosen having regard to one or both of the identify and category of the merchant site having the merchant computer.

In the method according to the invention, in which the user file is stored on one of:
a database; and
a cookie, and the user file may be stored in one or more of:
the user computer;
the merchant computer; and
a systems server computer.

In some of the embodiments of the invention, the preparatory steps further include obtaining information on the user and using the information to determine the logo to store.

The method according to the present invention is carried out in a number of sequential steps which are performed, namely:
the user browser computer contacts the merchant computer;
the user browser computer requests the downloading of a page;
the merchant computer sends a page with a request for the logo to the user browser computer;
the user browser computer requests the logo from the systems server computer by transferring the user file to the server computer;
the server computer sends the logo to the user browser computer; and
the user browser computer displays the page and logo.

Ideally, there is stored different sizes of the same logo in the user file and the size of logo is chosen for display having regard to one or both of:
the identity of the merchant computer; and
the call code of the page.

In many instances, more than one logo will be transmitted with the merchant page.

It is envisaged that the invention may be carried out by a computer program or programs comprising program instructions for causing a computer to carry out some or all of a method as described above. Such a computer program can be embodied on a record medium, stored in a computer memory, embodied in a read-only memory, and/or carried on an electrical carrier signal.

Further, the invention is also directed to providing a computer programmed to carry out some or all of the method, as described above.

### DETAILED DESCRIPTION OF THE INVENTION

The invention will be more clearly understood from the following description of some embodiments thereof, given by way of example only, with reference to the accompanying drawings in which:

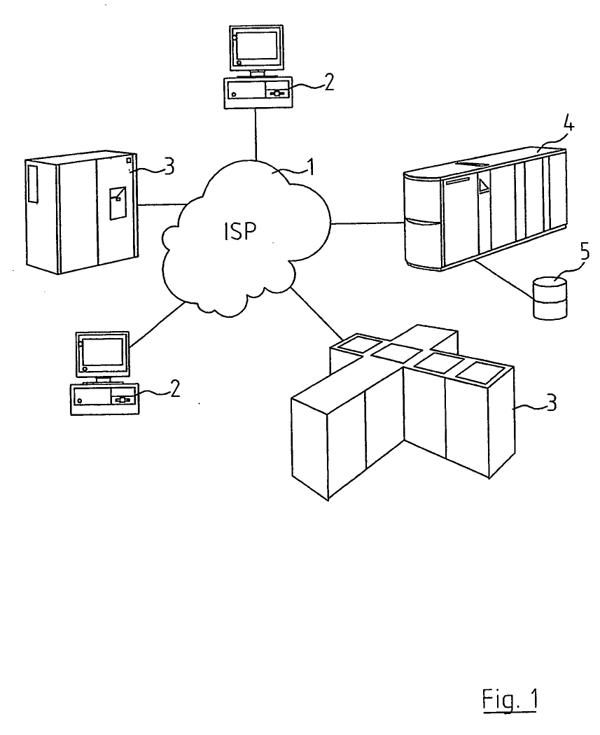

FIG. 1 is a diagrammatic view of a system in which the invention works, and

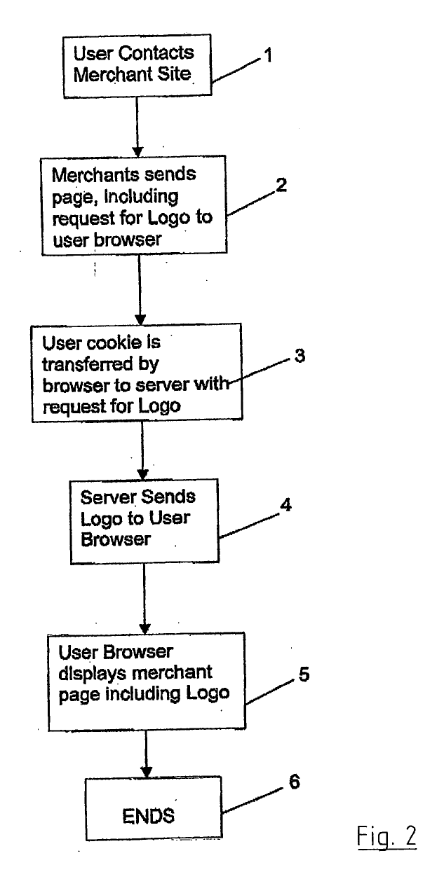

FIG. 2 is a flowchart of one method of carrying out the invention.

Referring to the drawings and initially to FIG. 1 thereof, there is provided an internet service provider 1 forming part of a communications network to which is connected a plurality of user computers 2, merchant computers 3 and one system server 4 having associated therewith, a database 5. Browser and other computers, as may be necessary, are not illustrated. There is stored on the database 5 for various types or classes of users, various logos. A typical classification of a user would be a customer of a particular financial institution using a specific payment card. Thus, each class of user has a particular logo and further, on the database, there is preferably stored different logos to be displayed, depending on the particular merchant site visited by the user computer 2, together with a logo identifier. Further, the user information is placed on a user file, which user file is stored in the database 5. Prior to operating the invention, each user is provided with a cookie which is stored in the user computer. The cookie stores the logo identifier or identifiers, as the case may be. It will be appreciated that for the system to work, both the user and the merchant have to join up and agree to be part of the system. As regards the users, it will obviously be in the interest of the credit card providers to encourage those people and entities they are dealing with, to join in the system. For the merchant, there are advantages in that the merchant will have a system that will be easier for the customer to use and therefore will be more likely to give rise to the satisfactory completion of a transaction. In any case, it is necessary for the merchant computer to join up in the system because the call code of the merchant page must include a request for the downloading of the logo or logos.

Referring now to FIG. 2, in operation, in step 1, the user computer through a user browser computer contacts a merchant computer on a merchant site, requesting a merchant page. In step 2, the merchant computer sends the requested page, including a request for a logo, to the user browser computer. The call code of the merchant page will include the request for the logo.

In step 3, the user cookie is transferred by the browser computer to the system server computer with the request for the logo.

In step 4, the system server computer sends the requisite logo to the user browser computer. Then, in step 5, the user browser computer sends the merchant page, including the logo, for display on the user computer. Then, in step 6, the transaction ends. It will be appreciated, however, that this portion of the operation ends, but not necessarily the session for the user computer.

In the embodiments described above, there has been described a database, although such a database is not necessarily essential. Indeed,, in many cases, there will not be a database but simply a collection of logos and user cookies. Essentially, the name of the logo is contained in the cookie and no identifying information about the user is on the cookie. Thus, it is not necessary to maintain a central database. However, in many instances, a central database may be used.

Generally, the logos and their identifiers will be stored on a separate database and the logo identifier will be stored on a user file, either as a cookie or on a database.

Depending on the type of merchant page which the user is visiting, an alternative logo may be displayed. This may occur in a situation where, for example, an adult content site merchant request to display a logo would result not in a normal logo for the user being displayed, but a different logo. One can well envisage a situation in that a financial institution, for example, providing a Visa card to a customer, might not necessarily want its name included on such a merchant site. Further, certain users may wish to use certain types of credit card with certain types of provider. Thus, for example, one particular user computer might use AMEX for all travel arrangements, while VISA for all food purchases.

While in the embodiment described above, a central server has been used, it will be appreciated that storage of the logo on the user's computer is a practical operation of the invention. This is also practical on a merchant site, however, it is only practical for a small number of logos but gets impractical as the number of logos grow and further, maintenance would become a major problem. However, the storing of the logos on a central server computer or central site which can be accessed by all merchants is the most practical implementation requiring only one source for all logos and making maintenance much less difficult and less expensive.

As it will be appreciated, information about the user needs to be stored. Again, this can be stored on the user's PC in a cookie provided by the merchant. While this is in common use today, it requires each merchant to have its cookie on every user PC. This unfortunately does not cater for the situation where the user is visiting a merchant site for the first time or where the user is otherwise unknown to the merchant. While, as explained above, they can be stored on the merchant site and is a common use for other cookies for use by merchants, it has limitations. The link between a user and a logo needs to be defined. This can be stored either with or linked to user information. For example, the following table could be displayed.

TABLE

| Service | User Attribute | ID of Logo to be displayed |
|---|---|---|
| Visa Payments | AIB | Visa AIB |
| Visa Payments | BOI | Visa BOI |
| Visa Payments | “None” | Visa Generic |
| Visa Payments | AIB & BOI | Visa Multi |

There are certain advantages in central storage in that only one version of a logo requires to be maintained and any changes are easily implemented without the involvement of a merchant who simply require to be supplied with the correct image as a page is being downloaded.

Further, many versions of the same logo may be maintained to cater for requirements such as size. Some merchants may like to display logos of one size, while others may prefer larger or smaller versions. Similarly, depending on the nature of the page being downloaded, the merchant may wish to adjust the size of the logo.

It will be appreciated that the nature of the present invention is such that, as a matter of course, many of the tasks required to carry out the invention will be performed outside the jurisdiction and possibly in many jurisdictions. Thus, where it is stated that a particular action is, or actions are, performed, it may be that only the end result of the action will be delivered into the jurisdiction. Thus, for example, the system server computer may be considerably geographically remote from the user computer, as well may be the merchant computer. Accordingly, all that may be stored on the user computer is a program or file sufficient to interface with other programs stored on other computers and thus the user computer will carry out very few steps of the invention. However, such steps cannot be performed without the availability of the data transmitted to or from it, with the other computers.

Therefore, it is submitted that the appended claims be interpreted not literally but having regard to this circumstance of use and that the carrying out of some of the steps of the invention in the jurisdiction covered by any patent for onward transmission of the results of the carrying out of those steps shall be deemed to be infringement in the sense that delivery into or receipt within the jurisdiction of the results of some steps of the method carried out outside the jurisdiction be deemed to be the same as if the steps had been carried out within the jurisdiction.

Accordingly, a statement that a particular computer carries out a particular task is deemed to cover, not alone the carrying out of the task or operation within the jurisdiction, but also the carrying out of the task outside the jurisdiction and the delivery of the result of the completion of the task to within the jurisdiction and the action required within the jurisdiction is the reception of the result of the action carried out outside the jurisdiction.

In the specification the terms “comprise, comprises, comprised and comprising” or any variation thereof and the terms “include, includes, included and including” or any variation thereof are considered to be totally interchangeable and they should all be afforded the widest possible interpretation and vice versa.

The invention is not limited to the embodiment hereinbefore described, but may be varied in both construction and detail.

1-31. (canceled)

32. A method of displaying on a user computer one or more logos, specific to the particular user, on the user computer contacting a website associated with a merchant computer in a communications system connecting the merchant computer and the user computer, the communications system being also connected to such additional systems server and user computers as may be necessary to carry out the method, having had the preparatory steps previously performed of:
preparing at least one logo for display on the user computer on the user computer contacting the merchant computer;
storing the logo and a logo identifier; and
additionally and separately storing the logo identifier on a user file;
then, on the user computer contacting a merchant computer and requesting the downloading of a merchant page having a call code, the steps are preformed of:
the user file is retrieved;
at least one logo identifier is extracted from the user file;
the logo identifier is used to extract the logo;
the logo is added to the merchant page; and
the logo and merchant page are sent to the user computer.

33. The method as claimed in claim 32, in which there is more than one logo identifier stored in the user file and on a request for downloading a merchant page the logo retrieved is chosen through user interactions.

34. The method as claimed in claim 32, in which the logo extracted is chosen having regard to one or both of the identify and category of the merchant site having the merchant computer.

35. The method as claimed in claim 32, wherein the user file is stored in one of:
a database; and
a cookie.

36. The method as claimed in claim 32, wherein the user file is stored on one or more of:
the user computer;
the merchant computer; and
a systems server computer.

37. The method as claimed in claim 32, in which the preparatory steps further include obtaining information on the user and using the information to determine a specific logo identifier to store.

38. The method as claimed in claim 32, in which sequentially the steps are preformed of:
the user computer contacts the merchant computer and requests the downloading of a page;
the merchant computer sends a page containing a request for the logo to the user computer;
the user computer requests the logo from the systems server computer by transferring the user file to the server computer;
the server computer sends the logo to the user computer; and
the user computer displays the page and logo.

39. The method as claimed in claim 32, in which there is stored different sizes of the same logo and the size of logo is chosen for display having regard to one or both of:
the identity of the merchant computer; and
the call code of the page.

40. A computer program comprising program instructions for causing a computer to carry out some or all of the method of claim 32.

41. The computer program as claimed in claim 40, embodied on a record medium.

42. The computer program as claimed in claim 40, stored in a computer memory.

43. A computer programmed to carry out some or all of the method of claim 32.

44. The method as claimed in claim 32 wherein each independent step is adapted to be sequentially carried out between two or more jurisdictions.

45. A method of displaying on a user computer one or more logos, specific to the particular user, on the user computer contacting a website associated with a merchant computer in a communications system connecting the merchant computer and the user computer, the communications system being also connected to such additional systems server and user computers as may be necessary to carry out the method, having had the preparatory steps previously performed of:
preparing at least one logo for display on the user computer on the user computer contacting the merchant computer;
storing the logo and a logo identifier; and
additionally storing the logo identifier on a user file;
the method comprising:
receiving notification of a request having been received by a merchant computer for the downloading of a merchant page having a call code;
retrieving the user file;
extracting at least one logo identifier from the user file;
retrieving the logo; and
having the logo sent for addition to the merchant page for display on the user computer.

46. A method of displaying on a user computer one or more logos, specific to the particular user, on the user computer contacting a website associated with a merchant computer in a communications system connecting the merchant computer and the user computer, the communications system being also connected to such additional systems server and user computers as may be necessary to carry out the method, some or all of the merchant computer and the additional systems server and user computers are outside the jurisdiction and for which method there is available for the user computer having been previously prepared, at least one logo for display on the user computer and a logo identifier stored on a user file, the method comprising:
the user computer contacts the merchant computer;
the user computer sends a request for the downloading of a merchant page having a call code;
said request comprising additional instructions for:
the retrieval of the user file;
extraction of at least one logo identifier from the user file;
retrieval of the logo;
the sending of the logo to the merchant computer with instructions to attach the logo to the merchant page;
and then, on the logo having been attached to the merchant page, the user computer receives the page and logo for subsequent use.

47. A method of retrieving via a communications network one or more logos, specific to the particular user and subsequently displaying said retrieved logo on display means associated with a user computer operable by a user, wherein the displayed logo is associated with further electronic data such that when the displayed logo is selected by the user that user is able to communicate with a merchant site in a predetermined manner, the method comprising the steps of:
(i) requesting a web page from a merchant computer adapted to run a website accessible via said communications network;
(ii) transmitting the requested web page and a request for a logo to the user computer;
(iii) transmitting the request for the logo accompanied by a logo identifier from the user computer to a computing server;
(iv) retrieving the logo identified by the identifier from a database associated with the computer server, and transmitting said retrieved logo to the user computer;
(v) displaying the logo and the web page on the user computer.

48. The method as claimed in claim 47, which includes the pre-performed initial steps of:
(i) preparing and storing the logo for subsequent display on the user computer;
(ii) associating an identifier with the logo so prepared, and
(iii) storing the identifier in a file associated with, and accessible by, the user computer.

49. The method as claimed in claim 47, wherein the further electronic data comprises instructions which facilitate a transaction between the user and the merchant.

50. The method as claimed in claim 47, wherein the further electronic data comprises instructions which enable payment to a merchant.

51. The method as claimed in claim 47 wherein each independent step is adapted to be sequentially carried out between two or more jurisdictions.
